(19) United States
(12) Patent Application Publication
(10) Pub. No.: US 2021/0374296 A1
(43) Pub. Date: Dec. 2, 2021

(54) SYSTEM AND METHOD FOR PROVIDING AN INTERACTIVE VIEW OF A PROPERTY, ASSOCIATED SYSTEMS AND DOCUMENTATION RELATED THERETO

(71) Applicant: Randy MINNIER, Poway, CA (US)

(72) Inventor: Randy MINNIER, Poway, CA (US)

(21) Appl. No.: 16/978,003

(22) PCT Filed: Mar. 5, 2019
(86) PCT No.: PCT/US2019/020697

§ 371 Date: Sep. 3, 2020

Related U.S. Application Data
(60) Provisional application No. 62/638,650, filed on Mar. 5, 2018.

(51) Int. Cl. G06F 30/13; G06F 30/12; G06F 3/0488; G06Q 10/00; G06F 16/909

(52) U.S. Cl. CPC G06F 30/13; G06F 30/12; G06F 2111/16; G06Q 10/20; G06F 16/909; G06F 3/04886

(57) ABSTRACT

Provided herein is an interactive mapping system (IMS) and equipment remote monitoring system (ERMS) application designed to deliver real-time digital information on a simple graphical user interface to map and locate building systems of a property of interest.

### CROSS REFERENCE TO RELATED APPLICATION(S)

This application claims the benefit of priority under 35 U.S.C. § 119(e) of U.S. Ser. No. 62/638,650, filed Mar. 5, 2018, the entire content of which is incorporated herein by reference.

### BACKGROUND OF THE INVENTION

### Field of the Invention

The invention relates generally to handheld/mobile devices and more specifically to systems and methods of providing interactive information and documentation about a property.

### Background Information

Buildings and common structures today demand precision and state of the art materials, components and equipment that can deliver and withstand round the clock operation from occupants and unpredictable surrounding conditions. The manual upkeep of such mentioned systems is very tedious and labor intensive which is costly and inefficient due to unavoidable human error and possible negligence. Failed equipment systems can lead to unexpected and unnecessary building operation shut down, and thus can result in business interference and extravagant profit loss.

Building management is a vital aspect of maintaining and protecting an existing structure and its occupants. Building information modeling (BIM) is generally a process of generating and managing building data for a building such as, for example, an office tower. BIM may include use of three-dimensional modeling software that takes into account, for example, building geometry, spatial relationships, and quantities and specification properties of various building components. BIM may involve modeling, for example, product norms of the various building components. The product norms may be extracted, for example, from specifications. One advantage of BIM is that it typically results in increased information sharing among architects, engineers, contractors, and customers. Consequently, BIM encourages more frequent and more effective interaction among stakeholders in a building-construction process. As BIM becomes more prevalent, architects, engineers, contractors, and customers increasingly desire more robust BIM solutions that enable, for example, real-time, accurate modeling and the potential to develop analytical insights about the performance of a building before building construction begins.

One particular difficulty with BIM is that the system does not provide enough information to operations managers and systems engineers of a particular building for upkeep of critical systems of the building, which results in users having to rely upon bits of information from multiple information management systems. Accordingly, there is a need for an automated building management system that incorporates cloud-based software to enable operations managers and systems engineers to avoid costly time losses and undesired building or product losses.

### SUMMARY OF THE INVENTION

The present invention is based on an interactive mapping system (IMS) and equipment remote monitoring system (ERMS) application designed to deliver real-time digital information on a simple graphical user interface to map and locate all building systems of a property of interest and provide real time information about each component of each system.

Accordingly, the present invention provides a system for monitoring and mapping features of a property. The system includes a data storage device having a property map database, a property systems database, and a document database; and a processor coupled to at least one display device, at least one input device, and a memory storing program instructions, wherein the processor is in communication with the data storage device. In various embodiments, the processor is configured to generate a user interface configured to receive commands from the at least one input device and display information about one or more of (a) the property; (b) critical systems of the property; or (c) specific equipment of the critical systems, on the at least one display device and execute the program instructions. Execution of the program instructions causes the processor to (i) receive and store a drawing of the property in the property map database; (ii) receive and store a list of equipment in the property systems database; (iii) receive and store one or more documents and information about the equipment in the document database; (iv) display in a first window geographic and locational information about the equipment on the drawing of the property in response to a first command; (v) display in a second window a visualization of a portion of the property with a scale showing a selected piece of equipment and depicting proportions for distances between the selected piece of equipment and other equipment stored in the property systems database; and (vi) display in a third window one or more documents related to the selected piece of equipment. Thus, information about the selected piece of equipment may be displayed in any of the first, second, or third windows in response to a second command.

In various embodiments, the processor is further configured to receive and store in the property map database one or more maps selected from the group consisting of a blueprint, Cartesian map, aerial photographic map, site plan map, and floor map of the property, and to display any map stored therein in response to a user command. In various embodiments, the processor is further configured to receive and store in the property systems database a list of critical systems of the property, and to display one or more of the critical systems on a map in response to a user command. In various embodiments, the processor may be further configured to activate the global positioning system (GPS) of the device to locate the critical system relative to the user's position. The critical systems may include one or more systems selected from the group consisting of a mechanical system, a plumbing system, an electrical system, and an emergency system. The mechanical systems may include one or more pieces of equipment selected from the group consisting of a chiller, a pump, a boiler, a cooling tower, a package unit, an HVAC unit, an exhaust fan, an air handler, and an elevator. The emergency system may include one or more pieces of equipment selected from the group consisting of a fire alarm, a fire sprinkler, internal fire panel, internal fire riser, gas shut-off, gas meter, lock box, and a security system. The electrical system may include one or more pieces of equipment selected from the group consisting of an electrical main service disconnect, electric service utility transformer, electric service panel, electric sub-panel, lighting systems, and electrical receptacles. The plumbing system may include one or more pieces of equipment selected from the group consisting of a main water shut-off, main sewer line, water delivery lines, and sewer subsystems. The one or more documents may be independently selected from the group consisting of a photograph, a user manual, an installation manual, a warranty card, a maintenance schedule, and a user note. The information about the equipment may include one or more of manufacturer, age, model, installation date, maintenance record and technician information, filter size and quantity, belt size and quantity, floor air zoning information, floor electrical service information, floor water service information, and electrical panel/circuit information.

In various embodiments, the processor is further configured to communicate with a printing device to print information about the selected equipment in response to a user command. In various embodiments, the processor is further configured to update one or more of the map database, property systems database, and document database in response to a user command. In various embodiments, the processor is further configured to communicate with a monitoring device or Building Management System, and to display a health and performance dashboard showing metrics about the property based on monitored data received from the monitoring device. The monitored data may include one or more of energy consumption data, transformer data, distribution board data, motor control data, uninterrupted power supply data, generator data, automatic transfer switch data, water consumption data, HVAC data, communications data, and security/access/surveillance data.

In another aspect, the invention provides a non-transitory computer readable medium encoded with processor executable instructions. Thus, when executed by at least one processor, the instructions cause the processor to (a) communicate with a data storage device having a property map database, a property systems database, and a document database; (b) generate a user interface configured to receive commands from at least one input device coupled to the processor and display information about a property on at least one display device coupled to the processor; (c) receive and store a drawing of the property in the property map database; (d) receive and store a list of equipment in the property systems database; (e) receive and store one or more documents and information about the equipment in the document database; (0 display in a first window geographic and locational information about the equipment on the drawing of the property in response to a first command; (g) display in a second window a visualization of a portion of the property with a scale showing a selected piece of equipment and depicting proportions for distances between the selected piece of equipment and other equipment stored in the property systems database; and (h) display in a third window one or more documents related to the selected piece of equipment. Thus, information about the selected piece of equipment may be displayed in any of the first, second, or third windows in response to a second command.

In another aspect, the invention provides a method of monitoring, mapping, and updating information about features (e.g. critical systems) of a property. The method includes using a computing device to access a data storage device having a property map database, a property systems database, and a document database, and using the computing device to receive and store a drawing of the property in the property map database, to receive and store a list of equipment in the property systems database, to receive and store one or more documents, pictures, notes and related information about the equipment in the document database, to display in a first window geographic and locational information about the equipment on a drawing or map of the property in response to a first command, to display in a second window a visualization of a portion of the property with a scale showing a selected piece of equipment and depicting proportions for distances between the selected piece of equipment and other equipment stored in the property systems database, and to display in a third window one or more documents related to the selected piece of equipment.

In yet another aspect, the invention provides a method for updating information in real-time about a feature of a property. The method includes using a computing device to access a data storage device having a property map database, a property systems database 18, and a document database, and using the computing device to perform one or more of the following edits: (i) change, add, or delete a drawing or map of the property in the property map database, (ii) change, add, or delete equipment to a list of equipment in the property systems database, (iii) change, add, or delete one or more documents, pictures, notes and related information about the equipment in the document database, or (iv) change, add, or delete a marker of denoting a specific piece of equipment of the property, and subsequently using the computing device to display in a first window geographic and locational information about the equipment on a drawing or map of the property in response to a first command, to display in a second window a visualization of a portion of the property with a scale showing a selected piece of equipment and depicting proportions for distances between the selected piece of equipment and other equipment stored in the property systems database, and to display in a third window one or more documents related to the selected piece of equipment.

### BRIEF DESCRIPTION OF THE DRAWINGS

FIG. 1 is a pictorial diagram showing an overall view of an exemplary embodiment of the system for monitoring and mapping features of a property.

FIG. 2 is a pictorial diagram showing an exemplary embodiment of the databases of the system.

FIG. 3 is a pictorial diagram showing exemplary information to be stored in the databases of the system.

FIG. 4 is a pictorial diagram showing exemplary wired/wireless communications between the various components of the system.

FIG. 5 is a pictorial diagram showing exemplary property data that can be monitored on a dashboard of the system.

FIG. 6 is a pictorial diagram showing an exemplary technician's computing device wirelessly communicating with the BMS of the system to be guided to equipment in need of maintenance.

FIG. 7 is a pictorial diagram showing an exemplary user interface displaying a site plan map of a property.

FIG. 8 is a pictorial diagram showing an exemplary user interface displaying associated information about specific markers on the site plan map.

FIG. 9 is a pictorial diagram showing an exemplary user interface displaying how a user places a marker for a specific piece of equipment and/or locates and/or updates information about a specific piece of equipment.

FIG. 10 is a pictorial diagram showing real-time scalability/editability of the system by a user.

FIG. 11 is a pictorial diagram showing an exemplary window listing the available markers to be added to a map of the system.

FIG. 12 is a pictorial diagram showing an exemplary user interface displaying the location and information of a specific piece of equipment.

FIG. 13 is a pictorial diagram showing an exemplary user interface displaying information about a specific electrical service panel (i.e., electrical panel schedule).

FIG. 14 is a pictorial diagram showing exemplary secondary and tertiary windows about a specific piece of equipment of a critical building system.

FIG. 15 is a pictorial diagram showing an exemplary user interface displaying a building health and performance dashboard about the property.

FIG. 16 is a flow diagram showing method steps that a user may perform while using the system.

### DETAILED DESCRIPTION OF THE INVENTION

The present invention is based on an interactive mapping system (IMS) and equipment remote monitoring system (ERMS) application designed to deliver real-time digital information on a simple graphical user interface to map and locate all building systems of a property of interest. For example, the system disclosed herein provides a user with the ability to monitor vital elements that keep a building operable and provide instant notifications about equipment in need of repair or maintenance. Likewise, the system provides a user with instant access to equipment location and documentation related thereto.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

The term “comprising,” which is used interchangeably with “including,” “containing,” or “characterized by,” is inclusive or open-ended language and does not exclude additional, unrecited elements or method steps. The phrase “consisting of” excludes any element, step, or ingredient not specified in the claim. The phrase “consisting essentially of” limits the scope of a claim to the specified materials or steps and those that do not materially affect the basic and novel characteristics of the claimed invention. The present disclosure contemplates embodiments of the invention compositions and methods corresponding to the scope of each of these phrases. Thus, a composition or method comprising recited elements or steps contemplates particular embodiments in which the composition or method consists essentially of or consists of those elements or steps.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

It will be understood that the present inventive concept can take the form of an entirely hardware embodiment, an entirely software embodiment or an embodiment containing both hardware and software elements. The present inventive concept may be implemented in software, which includes but is not limited to firmware, resident software, microcode, etc.

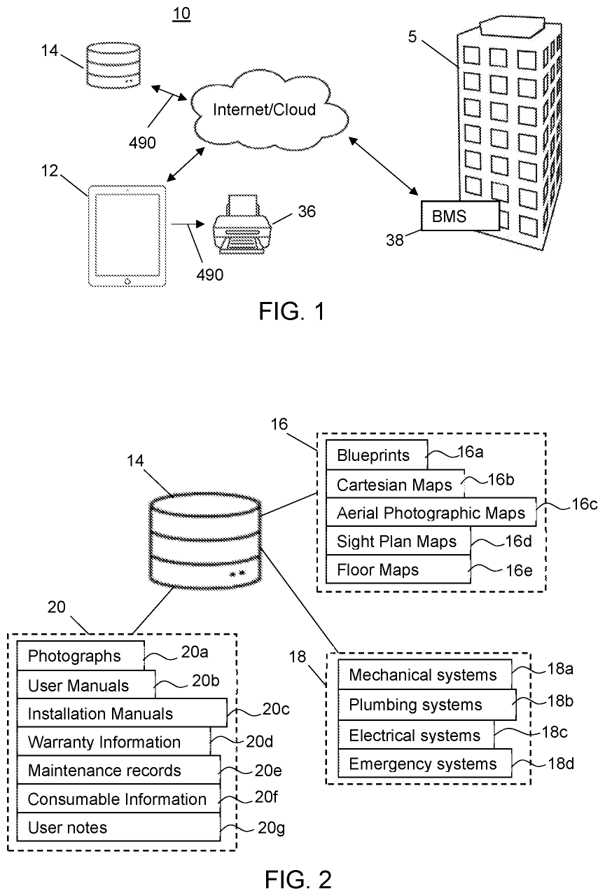

Referring now to FIGS. 1 and 2, an exemplary system 10 for monitoring and mapping features of a property is shown. As discussed herein, the system 10 or any part of the system 10 may be a part of, or may be executed by, one or more computing devices 12. A computing device 12 can be any type of computing device having one or more processors 30. For example, a computing device 12 can be a workstation, mobile device (e.g., a mobile/smart phone, tablet, personal digital assistant, or laptop), computer, server, computer cluster, server farm, game console, set-top box, kiosk, embedded system, and/or wearable device (e.g., wristband, watch, necklace, glasses, etc.) or other device having at least one processor 30 and memory 22. Embodiments of the present invention may therefore be software executed by a processor, firmware, hardware or any combination thereof in a computing device 12. According to a further embodiment, the system may be coupled to or may include one or more databases 14 including, but not limited to, a property map database 16, a property systems database 18, and a document database 20. The databases 14 may be stored in a single data storage device or may be stored in multiple data storage devices provided that the processor 30 of the computing device 12 is configured to communicate with each of the databases 14 as necessary to provide functionality for the user.

In various embodiments, the functionality of the system 10 of the present invention is preferably provided using web-based applications. In that way, a user (e.g., maintenance crew, facilities manager, building administrator, etc.) can access the functionality of the system 10 via a user interface of the computing device 12 (e.g., personal computer, laptop computer, tablet, personal digital assistant (PDA), smart phone, and/or wearable device (e.g., wristband, watch, necklace, glasses), etc.) using industry standard web browsers (e.g., the CHROME brand web browser from Google, Inc., the FIREFOX brand web browser from the Mozilla Foundation, the INTERNET EXPLORER/EDGE brand web browsers from the Microsoft Corporation, etc.). In certain embodiments, the functionality of the present invention is accessed via a user interface using a secure communication protocol (e.g., Hypertext Transfer Protocol Secure (HTTPS), Internet Protocol Security (IPsec), Datagram Transport Layer Security (DTLS), Secure Socket Tunneling Protocol (SSTP), etc.) so as to protect the database servers 14 from unauthorized access. In certain embodiments, the functionality of the present invention is accessed via a device-specific application configured to communicate with the one or more databases.

As will be appreciated by those having ordinary skill in that art, the systems, methods, and procedures described herein can be embodied in a programmable computer, computer executable software, or digital circuitry. The software can be stored on computer readable media. For example, “computer-coded,” “software,” “scripts,” “computer-readable software code,” and “programs” are software codes used interchangeably for the purposes of simplicity in this disclosure. Further, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

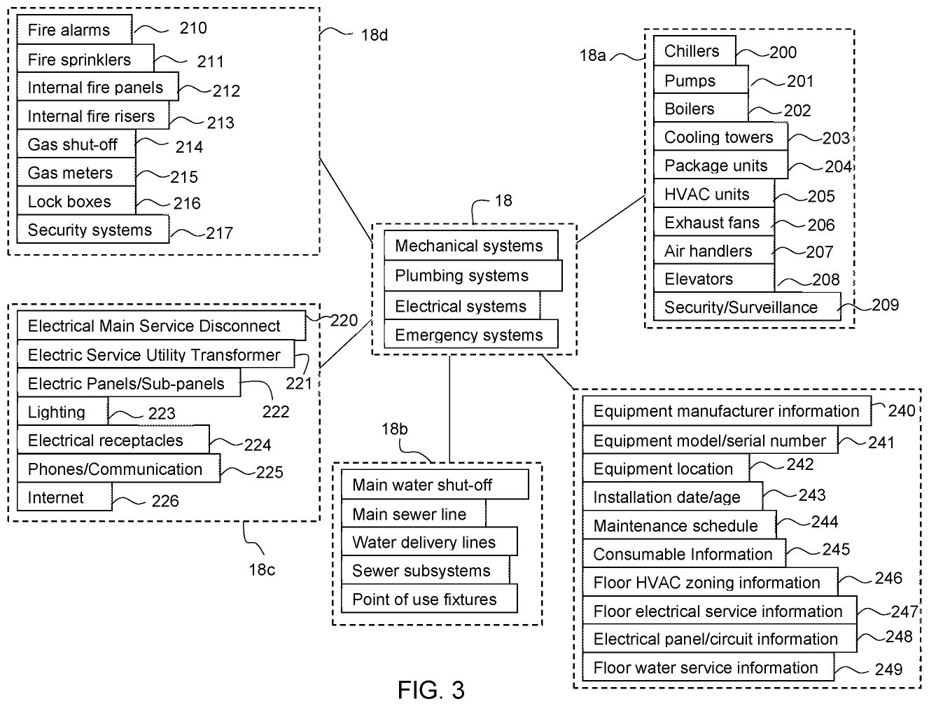

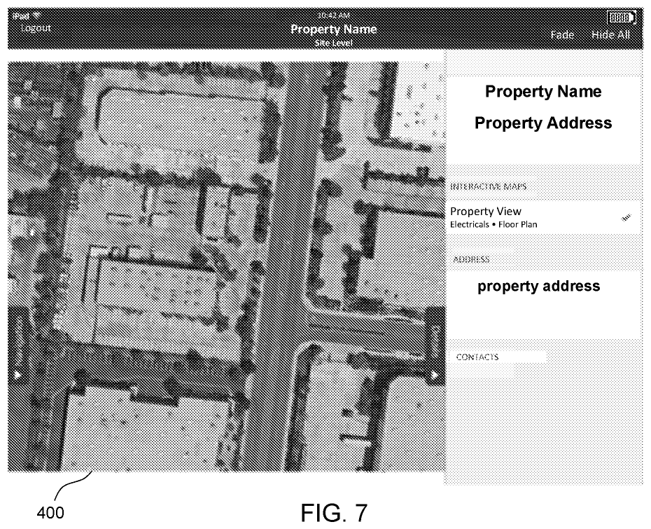

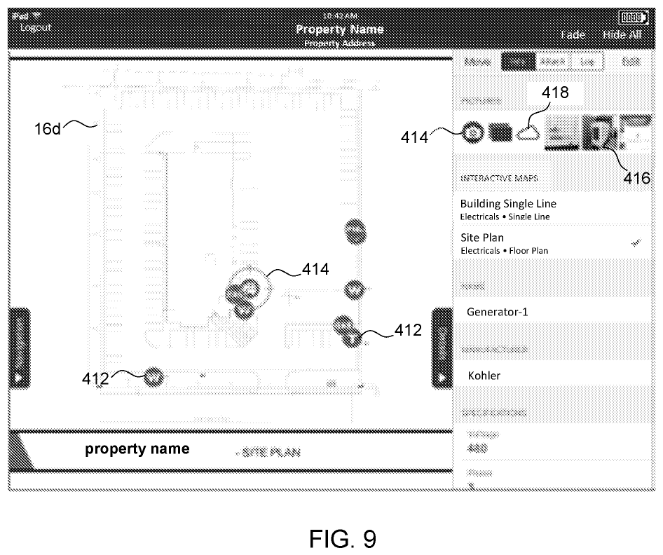

Accordingly, with reference now to FIGS. 1-4, the present invention provides a system 10 for monitoring and mapping features of a property 5. The system includes a data storage device 14 having a property map database 16, a property systems database 18, and a document database 20; and a processor 30 coupled to at least one display 24, at least one input device 26 (e.g., touchscreen, keyboard, etc.), and a memory 22 storing program instructions, wherein the processor 30 is in communication with the data storage device 14. In various embodiments, the processor 30 is configured to generate a user interface (see FIGS. 7-15) configured to receive commands from the at least one input device 26 (e.g., touchscreen or keypad) and display information on the display 24 thereof. The displayed information provides the user with information about one or more of (a) the property 5; (b) critical systems of the property (18a-18d); or (c) specific equipment of the critical systems (see FIG. 3). Execution of the program instructions causes the processor 30 to (i) receive and store various drawings and/or maps of the property 5 in the property map database 16; (ii) receive and store a list of equipment in the property systems database 18; (iii) receive and store one or more documents and information about the equipment in the document database 20; (iv) display in a first window geographic and locational information about the equipment on the drawing and/or map of the property in response to a first command; (v) display in a second window a visualization of a portion of the property with a scale showing a selected piece of equipment and depicting proportions for distances between the selected piece of equipment and other equipment stored in the property systems database 18; and (vi) display in a third window one or more documents related to the selected piece of equipment. Thus, information about the selected piece of equipment may be displayed in any of the first, second, or third windows on the display 24 in response to a user command.

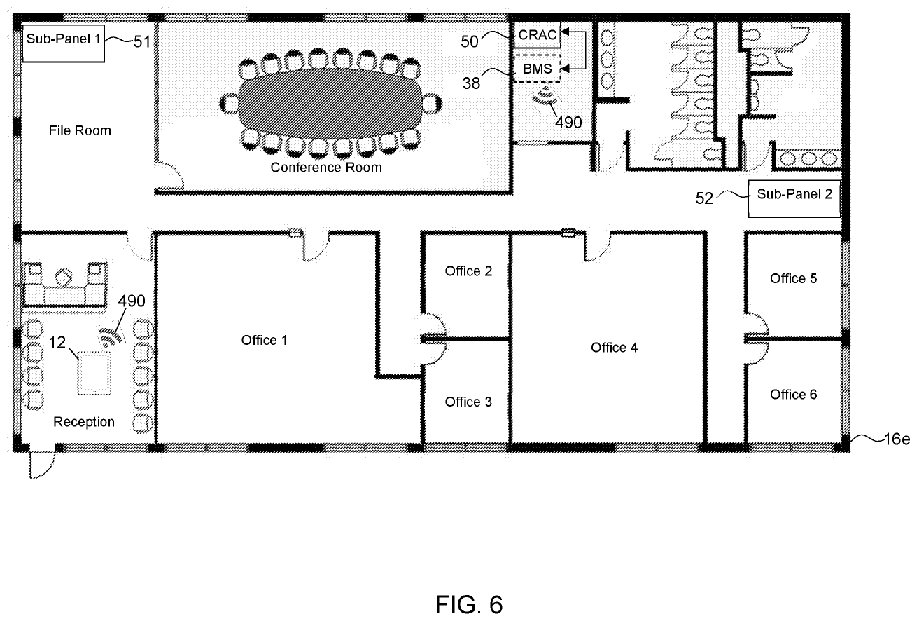

The property map database 16 is configured to receive, store, and provide access to one or more maps or drawings of the property 5. Such drawings or maps include, but are not limited to blueprints 16a, Cartesian maps 16b, aerial photographic maps 16c, site plan maps 16d, and floor/roof maps 16e of the property 5, such that a user has real-time access to any of the requested maps or drawings via the computing device 12. When so displayed, the interactive maps may be used to locate any equipment installed on or in the property 5. In various embodiments, the processor 30 may be further configured to activate the global positioning system (GPS) of the computing device 12 to locate the critical system relative to the user's position. As such, the system 10 may be used to track a location of the computing device 12 (and therefore, the user) and provide particular geographic location (e.g., latitude and longitude) and/or a location relative to another location within the property 5. For example, with reference to FIG. 6, tracking the location of the computing device 12 can include determining a direction of travel and/or an intended destination of the user on a particular floor of the property 5 using a floor map 16e from the property map database 16, along with the location(s) of the critical system (e.g., CRAC (50), sub-panel 1 (51) or sub-panel 2 (52), as shown). Once on the floor of the property 5, the technician's computing device 12 (i.e., tablet) may optionally communicate with the BMS 38 monitoring the critical systems of the property to accurately guide the technician to the location of the equipment requiring maintenance.

The property systems database 18 is configured to receive, store, and provide real-time access to a list of critical systems of the property 5, and information associated with such systems, in response to a user input command. Exemplary critical systems include, but are not limited to mechanical systems 18a, plumbing systems 18b, electrical systems 18c, and emergency systems 18d.

As shown in FIG. 3, exemplary mechanical systems 18a include, but are not limited to, chillers 200, pumps 201, boilers 202, cooling towers 203, package units 204, HVAC units 205, exhaust fans 206, air handlers 207, elevators 208, and security/surveillance equipment 209. Additional HVAC equipment includes, but is not limited to, heat pumps, condenser water pumps, chilled water pumps, expansion tanks, modular building/split unit fan coils, water source heat pumps, roof top units, ventilation units and computer room air conditioning (CRAC) units.

Exemplary emergency systems include, but are not limited to, fire alarms 201, fire sprinklers 211, internal fire panels 212, internal fire risers 213, gas shut-offs 214, gas meters 215, lock boxes 216, and security systems 217. Exemplary electrical systems include, but are not limited to, electrical main service disconnects 220, electric service utility transformers 221, electric service panels/sub-panels 222, lighting systems 223, electrical receptacles 224, phone/communications systems 225, and internet/Wi-Fi 226. Additional electrical systems include, but are not limited to, distribution boards, lighting systems, motor control cabinets, uninterruptible power supplies (UPS) and generators.

Exemplary plumbing systems include, but are not limited to, main water shut-offs 230, main sewer lines 231, water delivery lines 232, sewer subsystems 233, and point-of-use fixtures 234. For each piece of equipment of the critical systems of the property 5, the property systems database 18 may store information including, but not limited to, equipment manufacturer information 240, equipment model/serial number 241, equipment location 242, installation date and/or date of manufacture (age) 243, maintenance schedule 244, consumable information 245, floor HVAC zoning information 246, floor electrical service information 247, electrical panel/circuit information 248, and floor water service information 249.

The document database 20 is configured to receive, store, and provide real-time information specific to particular piece of equipment. Exemplary information includes, but is not limited to, photographs 20a, user manuals 20b, installation manuals 20c, warranty cards/information 20d, maintenance records 20e, consumables information 20f, and user notes 20g. As used herein, reference to “consumable” or “consumables” denotes services items essential to the functionality of a particular piece of equipment. For example, filter size and quantity, belt size and quantity, fuse size and quantity, etc. User notes may include the identification of the last technician to service the equipment, the brand/size/quantity of consumables used by the technician, and notations regarding future work required to maintain the equipment. Additionally, consumable information may include contact information (e.g., hyperlinks) to building vendors to schedule maintenance and/or instantly order and schedule delivery of consumables in view of upcoming maintenance requirements.

Accordingly, a user of the system 10 has real-time access to any information about a particular piece of equipment, such as one or more of manufacturer, age, model, installation date, maintenance record and technician information, filter size and quantity, belt size and quantity, floor air zoning information, floor electrical service information, floor water service information, and electrical panel/circuit information. In various embodiments, a user may simply hover the cursor of the computing device 12 over the equipment of interest and the display 24 will provide summary information (e.g., equipment type, manufacturer, and location) about the equipment.

In various embodiments, the processor 30 may be further configured to activate one or more cameras/scanners 28 of the computing device 12 to allow a user to take and upload new pictures of the equipment to the document database 20. Likewise, the camera 28 may be used to scan a visual identifier 34 affixed to the equipment for rapid identification thereof. Exemplary visual identifiers include, but are not limited to, hash codes, 2D barcodes, Quick Response (QR) codes or matrix barcodes, color codes, alphanumeric or other symbols. Such visual identifiers 34 may be stored as additional information in the document database 20 for rapid access to the above-discussed information about the equipment of a critical system.

In various embodiments, the system 10 may further include a printer 36 in wired or wireless communication with the computing device 12, such that a user may create new visual identifiers 34 or replace worn visual identifiers while at the location of the piece of equipment. Likewise, a user may print notes, service dates, calibration records and pictures of the piece of equipment at the time of service. Thus, a user may readily print updated service cards for a particular electrical panel, updated maintenance information about a particular piece of equipment, along with notes, and/or new or updated visual identifiers 36 or other labels. If so desired, the user may also print any of the manuals associated with the equipment of interest.

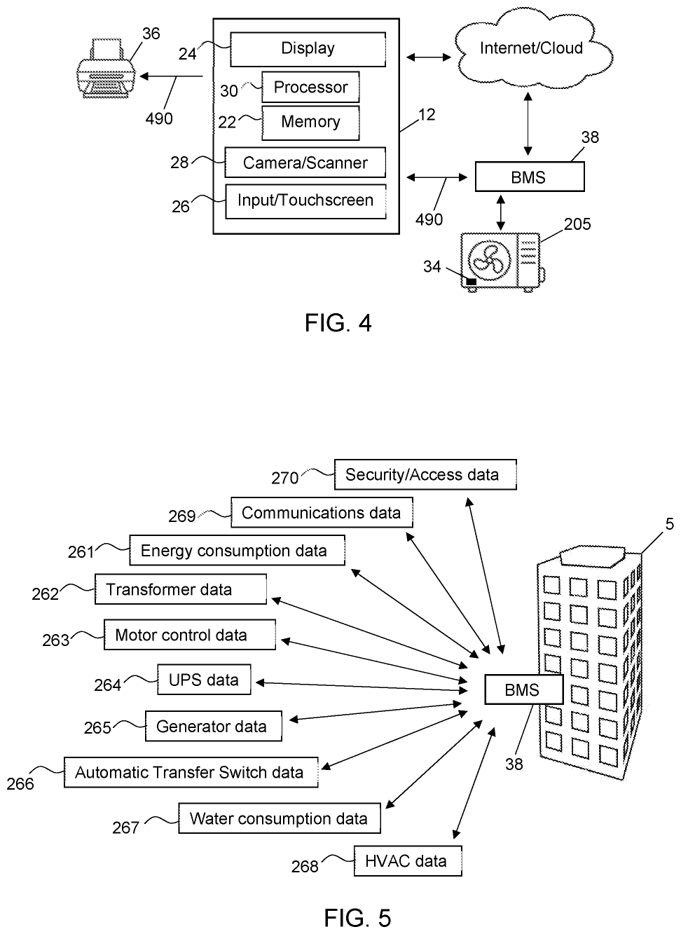

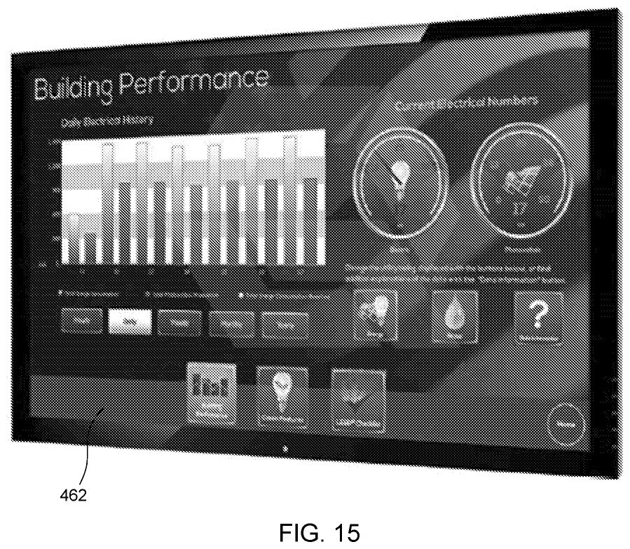

With reference now to FIGS. 1, 4 and 5, the system 10 may be configured to interface with a pre-existing or newly installed building management system (BMS) system 38. In various embodiments, the BMS 38 may communicate with one or more pieces of equipment in the property 5 via such communications protocols as Modbus, BacNet, and other open protocol systems. As shown in FIG. 15, the system 10 may be further configured to display a dashboard 260 to allow a user to monitor the overall health of the property 5, including consumption, readings and historic datalogging trend data. Thus, the dashboard 260 may be customized and/or configured to display virtually any graphic design by the user to display real-time information about the critical systems of the property 5. For example, the dashboard 260 may be configured to display critical information in the form of one or more meters, gauges, graphs, and other visual indicators relevant to the data being monitored. In various embodiments, the BMS 38 may be configured to communication directly with the computing device 12 via wireless communication protocol 490 when a user brings the computing device 12 into proximity of the property 5 (FIG. 4). Thus, the BMS may provide additional locational information about a specific piece of equipment to accurately locate the equipment within the property 5.

With reference now to FIG. 5, exemplary data that may be monitored by the BMS 38 and displayed on the dashboard 260 include, but are not limited to, energy consumption data 261, transformer data 262, motor control data 263, uninterruptible power supply (UPS) data 264, generator data 265, automatic transfer switch data 266, water consumption data 267, HVAC data 268, communications data 269, and security/access/surveillance data 270. As such, the system 10 may be configured to management overall energy consumption by the property 5 based on demand and/or time of day and/or day of the week. Further, the dashboard 260 may be configured to display alarms, view trends, maintenance schedules, manage a tenants' list, generate tenants' bills, schedule events, perform tuning/calibration, generate reports, scan for devices, detect and alert about network errors, add and edit a network, wireless commissioning reporting, manage network devices, manage IP (internet protocol), control building air handlers, control elevators, etc. The system 10 may be configured to provide interactive reporting, generate instant system alerts, alarms, notifications, and/or e-mails when one or more of the monitored data is out of acceptable range. In various embodiments, when the system 10 displays more than one alarm or alert, the system 10 may be configured to prioritize the alarms or alerts according to criticality of the system being monitored and/or energy demand and/or time of day and/or day of the week.

Accordingly, the present invention provides a system for monitoring and mapping features of a property that provides the advantages of increased availability of documents, increased knowledge of building systems, providing interactive records for all building systems, enhancing secured storage and data organization, providing detailed documentation of equipment, increasing building safety, increasing building efficiency, increasing building reliability, and the ability to schedule and track building equipment maintenance. Likewise, a user may provide access to the system 10 to any first responders and emergency personnel to clearly identify and locate site shut off and service locations, electrical main service disconnects, electric service utility transformer or on-site equipment, gas shut-offs and meters, internal annunciator panels, internal fire panels, internal fire risers, main water shut-off, and lock box locations.

In various embodiments, the system includes advanced security protocol the moment the system is installed on a device having a processor. Restrictive access through the system's login screen provides security such that only authorized users are able to access specific assigned characteristics of a given property. Thus, the system may be configured to view information about any one or more properties for which critical systems will be monitored and/or maintained.

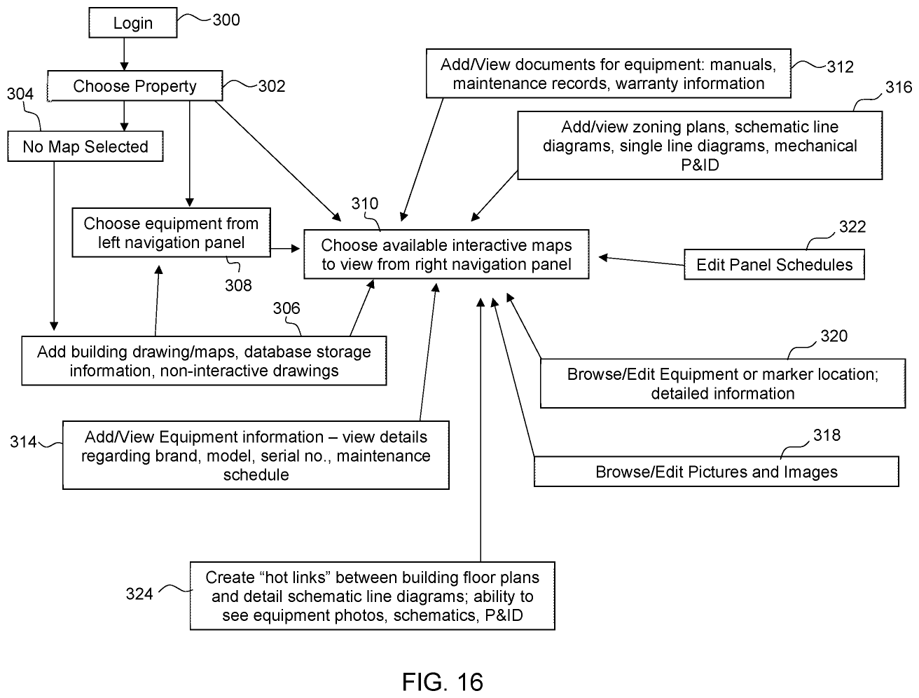

As shown in FIG. 16, the system is fully customizable to the needs of the user and/or property 5 being monitored. In various embodiments, after the user login 300, the user chooses a specific property 302 and is shown the property's introduction view with detailed information provided in a side panel. If no map is selected 304 and/or no map is saved in the property map database 16, the user may select a default map to display in the property's introduction view and/or add building drawings/maps 306 to the property map database 16. The user then may choose equipment from a side panel 308 and/or may choose any of the available interactive maps 310 to view the selected equipment. The user may upload/save/view documents 312 about the piece of equipment to the document database 20, and may upload/save/view equipment information 314 about the piece of equipment to the document database 20. The user may upload/save/view zoning plans, schematic line diagrams, and/or mechanical piping & instrumentation diagrams (P&IDs) 316 to any of the property map database 16, the property systems database 18, or the document database 20. The user may browse/edit pictures and images 318, browse/edit equipment or visual indicator 34 location 320, and/or browse/edit panel schedules 322. In addition, the user may create hot links 324 between building floor plans, detail schematic line diagrams, P&IDs, and photographs for rapid location and identification of equipment of interest.

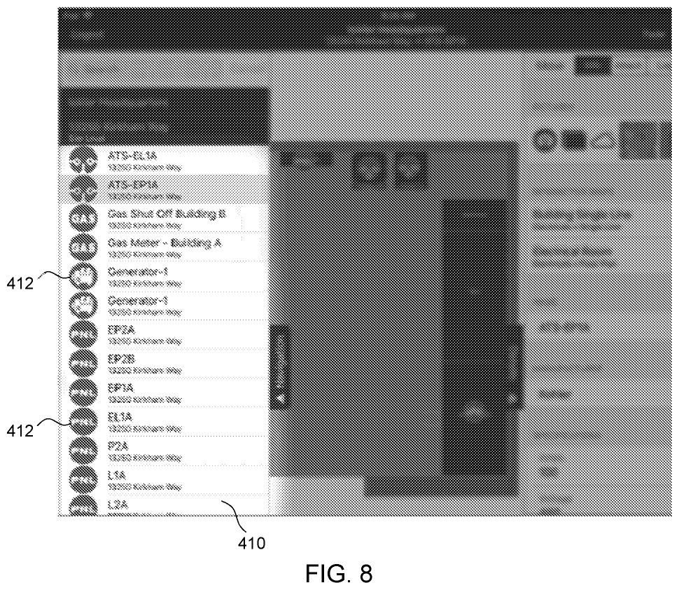

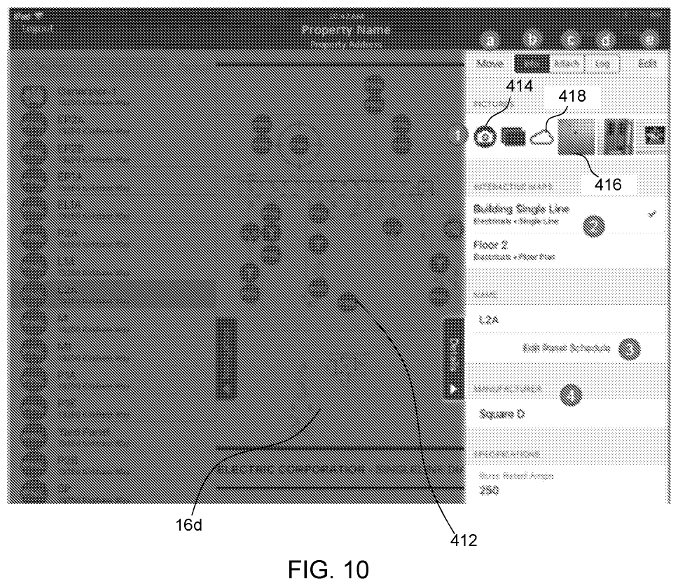

As shown in FIG. 7, the user may switch to a site plan 400 or blueprint map of the property 5 to locate a specific critical system and/or equipment of the specific critical system of interest. As shown in FIG. 8, a details panel 410 may be displayed in a side panel. The details panel 410 shows all associated information regarding a selected equipment, which is displayed as an icon or marker 412. As shown in FIG. 10, when viewing, for example, a site plan/single line map 16d, markers 412 can be moved (a) as appropriate, information about the relevant piece of equipment may be viewed (b), one or more attached (c) documents may be viewed about the equipment, log details (d) about the equipment may be viewed, and equipment information may be edited (e). The system is also configured to allow a user to take/store new pictures (1) 414, browse stored images 416, and share images 418 through email or collaborate with other technicians through a secured cloud storage. Each of the selected markers 412 may be linked to one or more alternative interactive maps/drawings (2) of the property to provide alternative views of the relevant systems to which they belong. Markers 412 may also be linked to electrical panel schedules (when applicable). Such panel schedules may be edited (3) and/or modified by a user in real-time, and all electrical calculations (e.g., load rating) are programmatically integrated within the application. Further, any relevant information about the equipment identified by the marker is also displayed in the side panel (4).

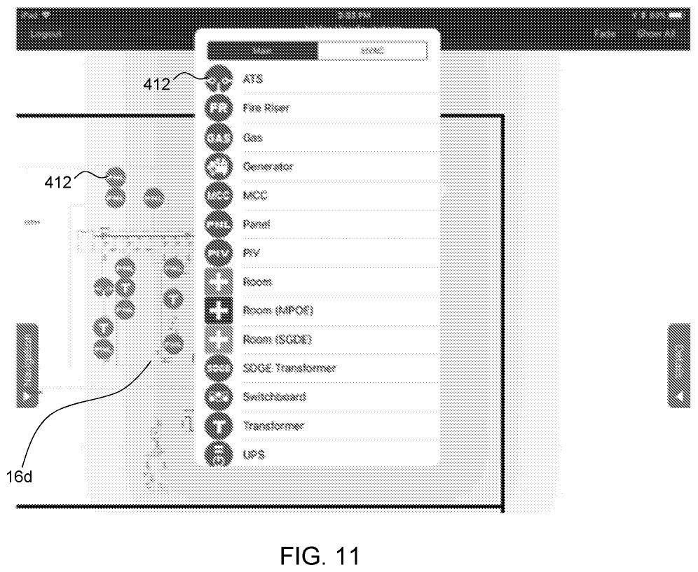

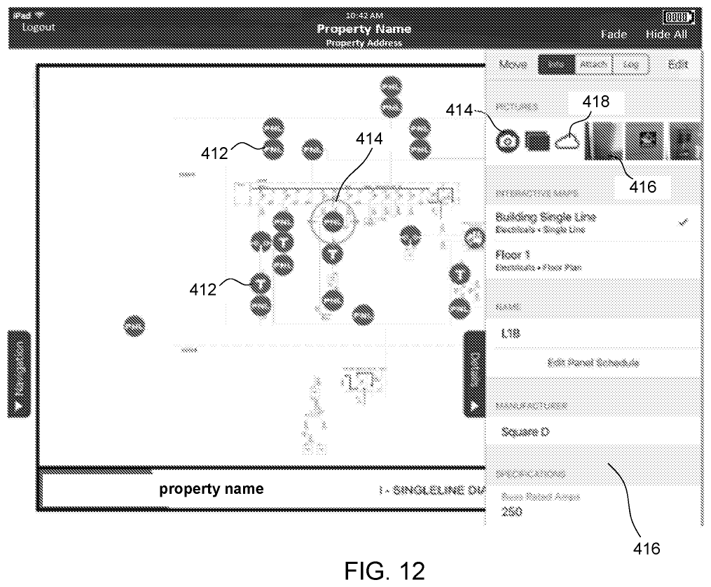

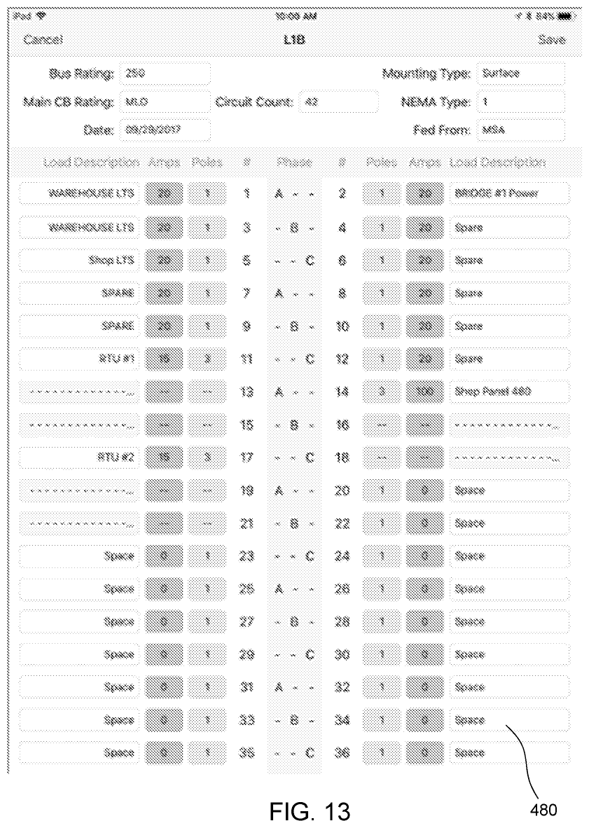

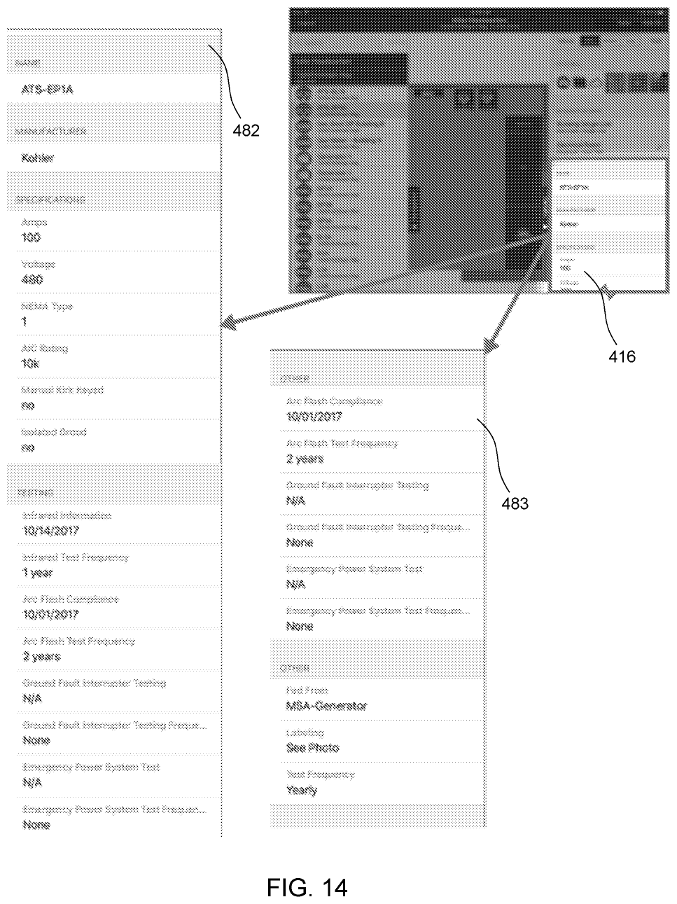

FIG. 11 shows an exemplary window of the system 10 that allows a user to place a marker 412 representing a specific piece of equipment on a map 16d. In various embodiments, the system 10 responds to a ‘press and hold’ command anywhere on a map view. In response, the system 10 will display a list of available markers 412 representing specific pieces of equipment. Thus, a user may create or modify the viewed maps such that building systems are able to be identified, and icons created per system type. Equipment details stored in the document database 20 allow a user to see equipment information in detail. FIG. 12 shows an exemplary window of the system 10 that allows a user to view information about specific equipment. In various embodiments, when a user selects a marker 412 on a map view, the selected marker is identified by a green target icon 414 and all available information is shown on a side navigation panel 416. FIG. 13 shows an exemplary window 480 displaying an electrical panel schedule with load calculations that are fully integrated within the system 10. As shown in FIG. 14, the load calculations may be altered in real-time in second 482 and third 483 windows as more circuits are added/deleted/moved by the user. Thus, the invention provides the user an effective off-site collaboration tool within the property.

Accordingly, in another aspect, the invention provides a method of monitoring, mapping, and updating information about features (e.g. critical systems) of a property. The method includes using a computing device 12 to access a data storage device 14 having a property map database 16, a property systems database 18, and a document database 20, and using the computing device to receive and store a drawing of the property in the property map database 16, to receive and store a list of equipment in the property systems database 18, to receive and store one or more documents, pictures, notes and related information about the equipment in the document database 20, to display in a first window geographic and locational information about the equipment on a drawing or map of the property 5 in response to a first command, to display in a second window a visualization of a portion of the property 5 with a scale showing a selected piece of equipment and depicting proportions for distances between the selected piece of equipment and other equipment stored in the property systems database, and to display in a third window one or more documents related to the selected piece of equipment.

In yet another aspect, the invention provides a method for updating information in real-time about a feature of a property. The method includes using a computing device 12 to access a data storage device 14 having a property map database 16, a property systems database 18, and a document database 20, and using the computing device to perform one or more of the following edits: (i) change, add, or delete a drawing or map of the property in the property map database 16, (ii) change, add, or delete equipment to a list of equipment in the property systems database 18, (iii) change, add, or delete one or more documents, pictures, notes and related information about the equipment in the document database 20, or (iv) change, add, or delete a marker of denoting a specific piece of equipment of the property 5, and subsequently using the computing device 12 to display in a first window geographic and locational information about the equipment on a drawing or map of the property 5 in response to a first command, to display in a second window a visualization of a portion of the property 5 with a scale showing a selected piece of equipment and depicting proportions for distances between the selected piece of equipment and other equipment stored in the property systems database, and to display in a third window one or more documents related to the selected piece of equipment.

Although the invention has been described with reference to the above example, it will be understood that modifications and variations are encompassed within the spirit and scope of the invention. Accordingly, the invention is limited only by the following claims.

1. A system for monitoring and mapping features of a property comprising:
(a) a data storage device having a property map database, a property systems database, and a document database; and
(b) a processor coupled to at least one display device, at least one input device, and a memory storing program instructions, wherein the processor is in communication with the data storage device and is configured to:
(b1) generate a user interface configured to receive commands from the at least one input device and display information about the property on the at least one display device;
(b2) execute the program instructions to:
(i) receive and store a drawing of the property in the property map database;
(ii) receive and store a list of equipment in the property systems database;
(iii) receive and store one or more documents and information about the equipment in the document database;
(iv) display in a first window geographic and locational information about the equipment on the drawing of the property in response to a first command;
(v) display in a second window a visualization of a portion of the property with a scale showing a selected piece of equipment and depicting proportions for distances between the selected piece of equipment and other equipment stored in the property systems database; and
(vi) display in a third window one or more documents related to the selected piece of equipment, and
(b3) communicate with a printer to print information about the selected equipment in response to a user command;
wherein information about the selected piece of equipment may be displayed in any of the first, second, or third windows in response to a second command.

2. The system of claim 1, wherein the processor is further configured to:
receive and store in the property map database one or more maps selected from the group consisting of a blueprint, Cartesian map, aerial photographic map, site plan map, and floor map of the property, and to display any map stored therein in response to a user command; and
receive and store in the property systems database a list of critical systems of the property, and to display one or more of the critical systems on the one or more maps in response to a user command.

3. (canceled)

4. The system of claim 2, wherein the list of critical systems comprises one or more systems selected from the group consisting of a mechanical system, a plumbing system, an electrical system, and an emergency system.

5. The system of claim 4, wherein the mechanical system comprises one or more pieces of equipment selected from the group consisting of a chiller, a pump, a boiler, a cooling tower, a package unit, an HVAC unit, an exhaust fan, an air handler, and an elevator.

6. The system of claim 4, wherein the emergency system comprises one or more pieces of equipment selected from the group consisting of a fire alarm, a fire sprinkler, internal fire panel, internal fire riser, gas shut-off, gas meter, lock box, a security system, and a surveillance system.

7. The system of claim 4, wherein the electrical system comprises one or more pieces of equipment selected from the group consisting of an electrical main service disconnect, electric service utility transformer, electric service panel, electric sub-panel, lighting systems, and electrical receptacles.

8. The system of claim 4, wherein the plumbing system comprises one or more pieces of equipment selected from the group consisting of a main water shut-off, main sewer line, water delivery lines, and sewer subsystems.

9. The system of claim 1, wherein:
the one or more documents are independently selected from the group consisting of a photograph, a user manual, an installation manual, a warranty card, a maintenance schedule, and a user note;
the information about the equipment includes one or more of manufacturer, age, model, installation date, maintenance record and technician information, filter size and quantity, belt size and quantity, floor air zoning information, floor electrical service information, floor water service information, electrical panel/circuit information, and a visual indicator specific to each piece of equipment, wherein the processor is further configured to activate a camera of a computing device to capture an image of the visual indicator of each piece of equipment in response to a user command; and
wherein the visual indicator is selected from the group consisting of a hash code, a 2D barcode, a Quick Response (QR) code, a matrix barcode, a color code, an alphanumeric code, and a symbol.

10-14. (canceled)

15. The system of claim 1, wherein:
the processor is further configured to communicate with a monitoring device or Building Management System, and to display a health and performance dashboard showing metrics about the property based on monitored data received from the monitoring device in response to a user command; and
the monitored data includes one or more of energy consumption data, transformer data, distribution board data, motor control data, uninterrupted power supply data, generator data, automatic transfer switch data, water consumption data, HVAC data, communications data, security data, and surveillance data.

16. (canceled)

17. The system of claim 1, wherein the processor is further configured to activate a global positioning system (GPS) of a computing device and to display a location of the equipment on the drawing of the property relative to the position of the processor in response to a command.

18. A non-transitory computer readable medium encoded with processor executable instructions that when executed by at least one processor, cause the at least one processor to:
(a) communicate with a data storage device having a property map database, a property systems database, and a document database;
(b) generate a user interface configured to receive commands from at least one input device coupled to the processor and display information about a property on at least one display device coupled to the processor;
(c) receive and store a drawing of the property in the property map database;
(d) receive and store a list of equipment in the property systems database;
(e) receive and store one or more documents and information about the equipment in the document database;
(f) display in a first window geographic and locational information about the equipment on the drawing of the property in response to a first command;
(g) display in a second window a visualization of a portion of the property with a scale showing a selected piece of equipment and depicting proportions for distances between the selected piece of equipment and other equipment stored in the property systems database;
(h) display in a third window one or more documents related to the selected piece of equipment; and
(i) communicate with a printing device to print information about the selected equipment in response to a user command,
wherein information about the selected piece of equipment may be displayed in any of the first, second, or third windows in response to a second command.

19. The non-transitory computer readable medium of claim 18, wherein the instructions further cause the at least one processor to:
receive and store in the property map database one or more maps selected from the group consisting of a blueprint, Cartesian map, aerial photographic map, site plan map, and floor map of the property, and to display any map stored therein in response to a user command; and
receive and store in the property systems database a list of critical systems of the property, and to display one or more of the critical systems on the one or more maps in response to a user command, wherein the list of critical systems comprises one or more systems selected from the group consisting of a mechanical system, a plumbing system, an electrical system, and an emergency system.

20. (canceled)

21. (canceled)

22. The non-transitory computer readable medium of claim 19, wherein the mechanical system comprises one or more pieces of equipment selected from the group consisting of a chiller, a pump, a boiler, a cooling tower, a package unit, an HVAC unit, an exhaust fan, an air handler, and an elevator.

23. The non-transitory computer readable medium of claim 19, wherein the emergency system comprises one or more pieces of equipment selected from the group consisting of a fire alarm, a fire sprinkler, internal fire panel, internal fire riser, gas shut-off, gas meter, lock box, and a security system.

24. The non-transitory computer readable medium of claim 19, wherein the electrical system comprises one or more pieces of equipment selected from the group consisting of an electrical main service disconnect, electric service utility transformer, electric service panel, electric sub-panel, lighting systems, and electrical receptacles.

25. The non-transitory computer readable medium of claim 19, wherein the plumbing system comprises one or more pieces of equipment selected from the group consisting of a main water shut-off, main sewer line, water delivery lines, and sewer subsystems.

26. The non-transitory computer readable medium of claim 18, wherein:
the one or more documents are independently selected from the group consisting of a photograph, a user manual, an installation manual, a warranty card, a maintenance schedule, and a user note; and
the information about the equipment includes one or more of manufacturer, age, model, installation date, maintenance record and technician information, filter size and quantity, belt size and quantity, floor air zoning information, floor electrical service information, floor water service information, and electrical panel/circuit information, and a visual indicator of each piece of equipment, wherein the processor is further configured to activate a camera of a computing device to capture an image of the visual indicator of each piece of equipment in response to a user command.

27-31. (canceled)

32. The non-transitory computer readable medium of claim 18, wherein:
the processor is further configured to communicate with a monitoring device and to display a health and performance dashboard showing metrics about the property based on monitored data received from the monitoring device; and
the monitored data includes one or more of energy consumption data, transformer data, distribution board data, motor control data, uninterrupted power supply data, generator data, automatic transfer switch data, water consumption data, HVAC data, communications data, security data, and surveillance data.

33. (canceled)

34. The non-transitory computer readable medium of claim 18, wherein the processor is further configured to activate a global positioning system (GPS) of a computing device and to display a location of the equipment on the drawing of the property relative to the position of the processor in response to a user command.

35. A method of monitoring, mapping, and updating information about features of a property comprising:
(a) using a computing device to access a data storage device having a property map database, a property systems database, and a document database; and
(b) using the computing device to:
(i) retrieve a drawing of the property in the property map database,
(ii) retrieve a list of equipment in the property systems database,
(iii) retrieve one or more documents, pictures, notes and related information about the equipment in the document database,
(iv) display in a first window of the computing device geographic and locational information about the equipment on a drawing or map of the property in response to a first command,
(v) display in a second window a visualization of a portion of the property with a scale showing a selected piece of equipment and depicting proportions for distances between the selected piece of equipment and other equipment stored in the property systems database, and
(vi) display in a third window one or more documents related to the selected piece of equipment,
wherein information about the selected piece of equipment may be displayed in any of the first, second, or third windows in response to a second command.

36. The method of claim 35, wherein:
the property map database comprises one or more maps selected from the group consisting of a blueprint, Cartesian map, aerial photographic map, site plan map, and floor map of the property; and
the property systems database comprises a list of critical systems of the property selected from the group consisting of a mechanical system, a plumbing system, an electrical system, and an emergency system.

37. (canceled)

38. The method of claim 36, wherein the mechanical system comprises one or more pieces of equipment selected from the group consisting of a chiller, a pump, a boiler, a cooling tower, a package unit, an HVAC unit, an exhaust fan, an air handler, and an elevator.

39. The method of claim 36, wherein the emergency system comprises one or more pieces of equipment selected from the group consisting of a fire alarm, a fire sprinkler, internal fire panel, internal fire riser, gas shut-off, gas meter, lock box, a security system, and a surveillance system.

40. The method of claim 36, wherein the electrical system comprises one or more pieces of equipment selected from the group consisting of an electrical main service disconnect, electric service utility transformer, electric service panel, electric sub-panel, lighting systems, and electrical receptacles.

41. The method of claim 36, wherein the plumbing system comprises one or more pieces of equipment selected from the group consisting of a main water shut-off, main sewer line, water delivery lines, and sewer subsystems.

42. The method of claim 35, wherein:
the one or more documents are independently selected from the group consisting of a photograph, a user manual, an installation manual, a warranty card, a maintenance schedule, and a user note; and
the information about the equipment includes one or more of manufacturer, age, model, installation date, maintenance record and technician information, filter size and quantity, belt size and quantity, floor air zoning information, floor electrical service information, floor water service information, and electrical panel/circuit information.

43. (canceled)

44. The method of claim 35, further comprising activating a camera of the computing device to capture an image of a visual indicator of the equipment, wherein the information about the equipment includes the visual indicator specific to the equipment.

45. (canceled)

46. (canceled)

47. The method of claim 35, further comprising activating a global positioning system (GPS) of the computing device to display a location of the equipment on the drawing of the property relative to the position of the computing device.
